(19) United States
(12) Patent Application Publication
(10) Pub. No.: US 2025/0021239 A1
(43) Pub. Date: Jan. 16, 2025

(54) STORAGE DEVICE, METHOD OF OPERATING STORAGE CONTROLLER, AND UFS SYSTEM

(71) Applicant: Samsung Electronics Co., Ltd., Suwon-si (KR)

(72) Inventors: Sungho YOON, Suwon-si (KR); Younsung CHU, Suwon-si (KR); Youngmoon KIM, Suwon-si (KR)

(73) Assignee: Samsung Electronics Co., Ltd., Suwon-si (KR)

(21) Appl. No.: 18/600,853

(22) Filed: Mar. 11, 2024

(30) Foreign Application Priority Data
Jul. 12, 2023 (KR) 10-2023-0090484

(51) Int. Cl. G06F 3/06

(52) U.S. Cl. CPC G06F 3/0619; G06F 3/0655; G06F 3/0679

(57) ABSTRACT

Provided are storage devices, methods of operating a storage controller, and universal flash storage (UFS) systems. The storage device includes a memory group configured to store unique device secret (UDS) data including a UDS, and pre-installed device secret (PDS) data including a PDS, and a processor configured to receive a first endorsement generated based on the PDS and a first firmware image, perform a first integrity check for the first firmware image based on the PDS of the PDS data, the first firmware image, and the first endorsement, and generate a second endorsement based on the UDS and the first firmware image in response to a pass result of the first integrity check.

### CROSS-REFERENCE TO RELATED APPLICATIONS

This application is based on and claims priority under 35 U.S.C. § 119 to Korean Patent Application No. 10-2023-0090484, filed on Jul. 12, 2023, in the Korean Intellectual Property Office, the disclosure of which is incorporated by reference herein in its entirety.

### BACKGROUND

The inventive concepts relate to electronic devices, and more particularly, to storage devices, a method of operating a storage controller, and a universal flash storage (UFS) system.

Semiconductor memory devices may be classified into volatile memories such as DRAM (Dynamic Random-Access Memory) and SRAM (Static RAM) and non-volatile memories such as EEPROM (Electrically Erasable Programmable Read-Only Memory), an FRAM (Ferroelectric RAM), PRAM (Phase-change RAM), MRAM (Magnetic RAM), and flash memory. A volatile memory device loses data stored therein when the power supply to the volatile memory is cut off, whereas a non-volatile memory device retains data stored therein even when power to the non-volatile memory is cut off.

Devices using non-volatile memory include, for example, MP3 players, digital cameras, mobile phones, camcorders, flash cards, and solid state disks (SSDs). As devices that use non-volatile memories as storage devices increase, the capacity of non-volatile memories is rapidly increasing.

Integrity is required for a storage device including a non-volatile memory, and it is important to maintain security from side-channel attacks by malicious attackers. Therefore, research is being conducted to increase the security of storage devices.

### SUMMARY

The inventive concepts provide storage devices, methods of operating a storage controller, and universal flash storage (UFS) systems to prevent or reduce security incidents due to pre-installed device secret (PDS) leakage, side channel attacks, etc.

According to some aspects of the inventive concepts, there is provided a storage device including a memory group configured to store unique device secret (UDS) data including a UDS, and pre-installed device secret (PDS) data including a PDS, and a processor configured to receive a first endorsement generated based on the PDS and a first firmware image, perform a first integrity check for the first firmware image based on the PDS of the PDS data, the first firmware image, and the first endorsement, and generate a second endorsement based on the UDS and the first firmware image in response to a pass result of the first integrity check.

According to some aspects of the inventive concepts, there is provided a method of operating a storage controller, the method including receiving a first endorsement generated based on a pre-installed device secret (PDS) and a first firmware image, performing a first integrity check for the first firmware image based on the PDS of pre-stored PDS data, the first firmware image, and the first endorsement, and, in response to a pass result of the first integrity check, generating a second endorsement based on a unique device secret (UDS) of pre-stored UDS data and the first firmware image.

According to some aspects of the inventive concepts, there is provided a universal flash storage (UFS) system including a UFS host configured to generate a first endorsement based on a pre-installed device secret (PDS) and a first firmware image and transmit the first endorsement and the first firmware image, and a UFS device configured to update firmware based on the first endorsement and the first firmware image. The UFS device includes a memory group storing unique device secret (UDS) data including a UDS and PDS data including the PDS, a processor configured to perform a first integrity check for the first firmware image based on the PDS of the PDS data, the first firmware image, and the first endorsement and, in response to a pass result of the first integrity check, generate a second endorsement based on the UDS, and a non-volatile memory configured to store the second endorsement and the first firmware image.

### BRIEF DESCRIPTION OF THE DRAWINGS

Example embodiments of the inventive concepts will be more clearly understood from the following detailed description taken in conjunction with the accompanying drawings in which:

FIG. 1 is a block diagram showing a storage system according to some example embodiments;

FIG. 2 is a diagram for describing an interface between a host and a storage device, according to some example embodiments;

FIG. 3 is a block diagram showing a device controller according to some example embodiments;

FIG. 4 is a diagram for describing a method of operating a system, according to some example embodiments;

FIG. 5 is a diagram for describing an example embodiment of generating a first endorsement;

FIG. 6 is a flowchart for describing a method of performing an integrity check, according to some example embodiments;

FIG. 7 is a diagram for describing a method of operating a system, according to some example embodiments;

FIG. 8 is a flowchart for describing a method of performing a first integrity check and a second integrity check, according to some example embodiments;

FIG. 9 is a diagram for describing an example embodiment of generating a second endorsement;

FIG. 10 is a diagram for describing an example embodiment of storing a second endorsement in a non-volatile memory;

FIG. 11 is a flowchart of a method of operating a storage controller, according to some example embodiments;

FIG. 12 is a flowchart of a method of operating a storage controller, according to some example embodiments;

FIG. 13 is a diagram for describing a universal flash storage (UFS) system according to embodiments; and

FIGS. 14A, 14B, and 14C are diagrams for describing the form factor of a UFS card.

### DETAILED DESCRIPTION

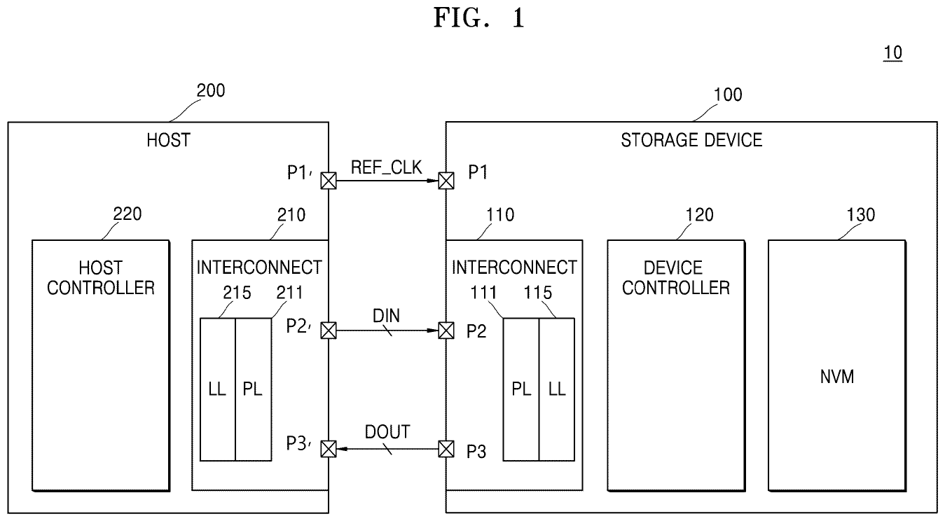

FIG. 1 is a block diagram showing a storage system according to some example embodiments.

Referring to FIG. 1, a storage system 10 may include a storage device 100 and a host 200. For example, the storage device 100 and the host 200 may be connected to each other according to an interface protocol defined in the universal flash storage (UFS) standard. Therefore, the storage device 100 may be a UFS device and the host 200 may be a UFS host. However, the inventive concepts are not limited thereto, and the storage device 100 may be connected to the host 200 according to various standard interfaces.

The host 200 may control a data processing operation for the storage device 100, e.g., a data read operation or a data write operation. The host 200 may refer to a data processing device capable of processing data, e.g., a central processing unit (CPU), a processor, a microprocessor, an application processor (AP), etc. The host 200 may execute an operating system (OS) and/or various applications. In some example embodiments, the storage system 10 may be included in a mobile device, and the host 200 may be implemented as an AP. In some example embodiments, the host 200 may be implemented as a system-on-a-chip (SoC), and thus, the host 200 may be embedded in an electronic device.

The host 200 may include an interconnect 210 and a host controller 220.

The host 200 may provide a reference clock REF_CLK to the storage device 100. The frequency of the reference clock REF_CLK may be determined to be one of various frequencies, such as 19.2 MHz, 26 MHz, 38.4 MHz, 52 MHz, etc. According to some example embodiments, the number of selectable frequencies of the reference clock REF_CLK may be four: 19.2 MHz, 26 MHz, 38.4 MHz, and 52 MHz, but the inventive concepts are not limited thereto. According to some example embodiments, the host 200 may generate the reference clock REF_CLK during an initialization stage or a booting stage of the storage system 10 and may provide a generated reference clock REF_CLK to the storage device 100. According to some example embodiments, the host 200 may continue to generate the reference clock REF_CLK while the storage system 10 is operating and may continue to provide generated reference clocks REF_CLK to the storage device 100.

The storage device 100 is implemented as an eMMC (Embedded Multi-Media Controller) for automotive or a UFS and may perform secure boot. However, the inventive concepts are not limited thereto. The storage device 100 may include an interconnect 110, a device controller 120, and a non-volatile memory 130. The device controller 120 may control the non-volatile memory 130 to write data to the non-volatile memory 130 in response to a write request received from the host 200. Alternatively, or additionally, the device controller 120 may control the non-volatile memory 130 to read data stored in the non-volatile memory 130 in response to a read request received from the host 200. Although FIG. 1 shows that the interconnect unit 110 and the device controller 120 are separate components, the device controller 120 may include the interconnect 110. For example, when the device controller 120 is implemented as a single package chip, the interconnect 110 may also be implemented in the single package chip. The device controller 120 of this disclosure may be referred to as a storage controller.

When power is applied to the storage system 10, the host 200 provides the reference clock REF_CLK to the storage device 100, and the device controller 120 may receive the reference clock REF_CLK and determine the frequency of the received reference clock. Therefore, the storage device 100 does not need to additionally receive frequency information regarding the reference clock REF_CLK from the host 200.

The non-volatile memory 130 may include a plurality of memory cells. For example, the memory cells may be flash memory cells. According to some example embodiments, the memory cells may be NAND flash memory cells. However, the inventive concepts are not limited thereto, and, in some example embodiments, the memory cells may be resistive memory cells such as resistive RAM (ReRAM) cells, phase change RAM (PRAM) cells, and/or magnetic RAM (MRAM) cells.

The host 200 may further include a first pin P1′ and may transmit the reference clock REF_CLK to the storage device 100 through the first pin P1′. The storage device 100 may further include a first pin P1 configured to be connected to the first pin P1′ and receive the reference clock REF_CLK from the host 200 through the first pin P1. In this regard, the reference clock REF_CLK may be transmitted from the host 200 to the storage device 100 through the first pins P1′ and P1, and thus, the first pins P1′ and P1 may be referred to as “reference clock pins”. According to some example embodiments, the storage device 100 may receive the reference clock REF_CLK from the host 200 through the first pin P1 during an initialization phase or a booting phase of the storage device 100.

The host 200 may further include second and third pins P2′ and P3′, and the storage device 100 may further include second and third pins P2 and P3 configured to be connected to the second and third pins P2′ and P3′, respectively. Since the host 200 may transmit an input signal DIN to the storage device 100 through second pins P2′ and P2, the second pins P2′ and P2 may be referred to as “input signal pins”. According to some example embodiments, the input signal DIN may be a differential input signal, and thus, the host 200 may include two second pins P2′ and the storage device 100 may include two second pins P2. Since the storage device 100 may transmit an output signal DOUT to the host 200 through third pins P3′ and P3, the third pins P3′ and P3 may be referred to as “output signal pins”. According to some example embodiments, the output signal DOUT may be a differential input signal, and thus, the host 200 may include two third pins P3′ and the storage device 100 may include two third pins P3.

The interconnects 110 and 210 may provide an interface for exchanging data between the host 200 and the storage device 100. In some example embodiments, the interconnect 110 may include a physical layer (PL) 111 and a link layer (LL) 115, and the PL 111 may be connected to second and third pins P2 and P3. In the same regard, the interconnect 210 may also include a PL 211 and an LL 215, and the PL 211 may be connected to second and third pins P2′ and P3′. The PL 111 and the PL 211 may each include physical components for exchanging data between the host 200 and the storage device 100, e.g., at least one transmitter and at least one receiver. The LL 115 and the LL 215 may each manage transmission and composition of data and may also manage integrity and errors of data.

In some example embodiments, when the storage system 10 is a mobile device, LLs 115 and 215 may be defined by the “UniPro” specification and PLs 111 and 211 may be defined by the “M-PHY” specification. The UniPro and the M-PHY are interface protocols proposed by the Mobile Industry Processor Interface (MIPI) Alliance. In this case, the LLs 115 and 215 may each include a physical adapted layer. The physical adapted layer may control the PLs 111 and 211 to manage symbols of data or manage power. The interface between the host 200 and the storage device 100 will be described below.

According to some example embodiments, even when a pre-installed device secret (PDS) is leaked or an attacker launches a side-channel attack on the storage device 100, security incidents that may occur due to such events may be prevented or reduced in devices such as an eMMC and a UFS in which asymmetric encryption techniques are difficult to use.

Also, the overhead of booting time in devices such as an eMMC and a UFS in which asymmetric encryption techniques are difficult to use may be reduced. Additionally, by using the above example embodiments, data may be more securely stored and the ability of malicious actors to access sensitive data, confidential data, technical data, etc., of the storage devices may be decreased and/or have reduced ability. Therefore, the improved devices and methods overcome the deficiencies of the conventional devices and methods related to asymmetric encryption while reducing resource consumption and increasing data clarity/security. For example, by using the disclosed methods, the boot operation and operation of a device, particularly relating to the use of a device with a UDS and PDS, may be possible and require fewer resources, such as memory access and/or power to drive circuitry to protect stored data.

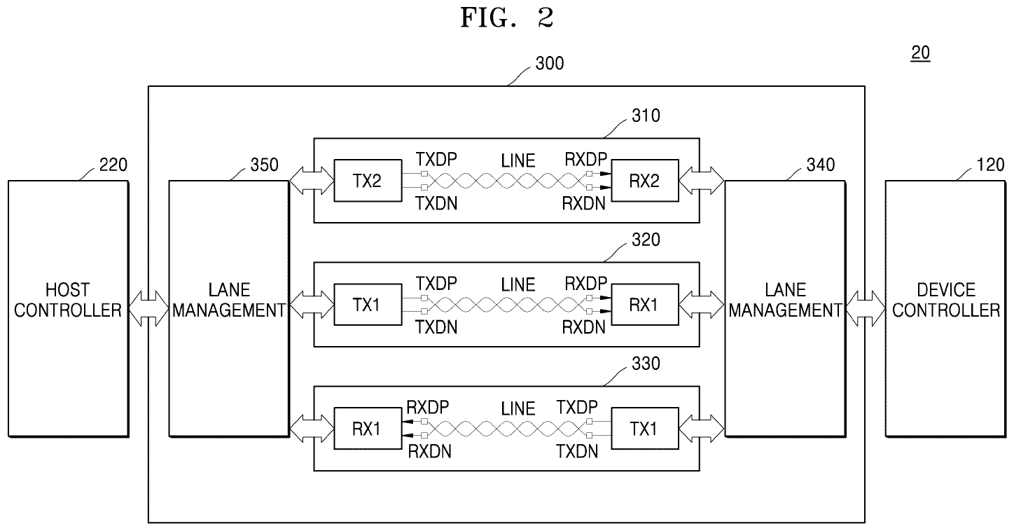

FIG. 2 is a diagram for describing an interface between a host and a storage device, according to some example embodiments.

Referring to FIG. 2, an interface 20 may include a link 300 between the host controller 220 and the device controller 120, wherein the link 300 may include a plurality of lanes 310, 320, and 330. The link 300 may include at least one lane corresponding to each direction, and the number of lanes in each direction may not necessarily be symmetric. For example, the link 300 may include two lanes 310 and 320 corresponding to a first direction from the host controller 220 to the device controller 120 and one lane 330 corresponding to a second direction from the device controller 120 to the host controller 220, but the inventive concepts are not limited thereto.

Each of the lanes 310, 320, and 330 includes a transmission channel that carries unidirectional and single-signal information. For example, a lane 320 may include a transmitter TX1, a receiver RX1, and a line LINE for point-to-point interconnection between the transmitter TX1 and the receiver RX1. For example, the transmitter TX1 may be connected to a pin TXDP corresponding to a positive node of a differential signal and a pin TXDN corresponding to a negative node of the differential signal, whereas the receiver RX1 may be connected to a pin RXDP corresponding to the positive node of the differential signal and a pin RXDN corresponding to the negative node of the differential signal. The line LINE includes two differentially routed wires for respectively connecting pins TXDP and RXDP and pins TXDN and RXDN of the transmitter TX1 and the receiver RX1, wherein the wires may correspond to transmission lines.

The link 300 may further include lane management units 340 and 350 that provide a bidirectional data transmission function. Although FIG. 2 shows that the lane management unit 350 and the host controller 220 are separated from each other, the inventive concepts are not limited thereto, and the lane management unit 350 may be included in the host controller 220. In the same regard, although FIG. 2 shows that a lane management unit 340 and the device controller 120 are separated from each other, the inventive concepts are not limited thereto, and the lane management unit 340 may be included in the device controller 120.

Referring to FIGS. 1 and 2 together, a transmitter included in the interconnect 210 of the host 200 and a receiver included in the interconnect 110 of the storage device 100 may constitute one lane. However, the numbers of transmitters and receivers included in the interconnect 210 of the host 200 may be different from the numbers of transmitters and receivers included in the interconnect 110 of the storage device 100. Also, the capability of the host 200 may be different from that of the storage device 100.

Therefore, the host 200 and the storage device 100 may perform a process of recognizing a lane that is physically connected therebetween and receiving information from each other. Therefore, the host 200 and the storage device 100 may perform a link startup process before exchanging data therebetween. By performing the link startup process, the host 200 and the storage device 100 may exchange and recognize information regarding the numbers of transmitters and receivers, information regarding physically connected lanes, and information regarding capability of each other. After the link startup process is completed, the host 200 and the storage device 100 may be set to a linked-up state in which data is stably exchanged with each other.

The link startup process may be performed during an initialization operation performed when the storage system 10 is used for the first time or during a boot operation of the storage system 10. Furthermore, the link startup process may be performed during an operation of recovering an error in the linked-up state. However, the link startup process may take a long time because a large amount of information regarding the host 200 and the storage device 100 needs to be exchanged.

According to some example embodiments, the storage device 100 may be implemented as a DRAMless device, and the DRAMless device may refer to a device that does not include DRAM cache. In this case, the device controller 120 may not include a DRAM controller. For example, the storage device 100 may use a partial region of the non-volatile memory 130 as a buffer memory.

According to some example embodiments, the storage device 100 may be an internal memory embedded in an electronic device. For example, the storage device 100 may be an embedded UFS memory device, an embedded multi-media card (eMMC), or a solid state drive (SSD). However, the inventive concepts are not limited thereto, and the storage device 100 may include a non-volatile memory, e.g., one-time programmable ROM (OTPROM), programmable ROM (PROM), erasable and programmable ROM (EPROM), electrically erasable and programmable ROM (EEPROM). mask ROM, flash ROM, etc. According to some example embodiments, the storage device 100 may be an external memory detachable from an electronic device. For example, the storage device 100 may include at least one of a UFS memory card, a compact flash (CF) card, a secure digital (SD) card, a micro secure digital (SD) card, a mini secure digital (SD) card, an extreme digital (xD) card, and a memory stick.

The storage system 10 may be implemented as an electronic device, e.g., a personal computer (PC), a laptop computer, a mobile phone, a smartphone, a tablet PC, a personal digital assistant (PDA), an enterprise digital assistant (EDA). a digital still camera, a digital video camera, an audio device, a portable multimedia player (PMP), a personal navigation device or portable navigation device (PND), an MP3 player, a handheld game console, an e-book terminal, etc. Also, the storage system 10 may be implemented as various types of electronic devices including wearable devices, e.g., a wristwatch or a head-mounted display (HMD).

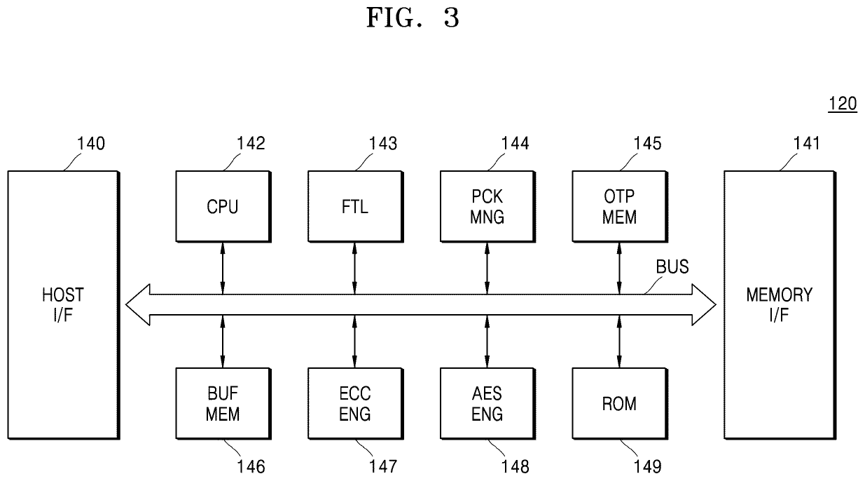

FIG. 3 is a block diagram showing a device controller according to some example embodiments.

Referring to FIG. 3, the device controller 120 may include a host interface 140, a memory interface 141, and a CPU 142. Also, the device controller 120 may further include a flash translation layer (FTL) 143, a packet manager 144, one-time programmable (OTP) memory (OTP MEM) 145, a buffer memory 146, an error correction code (ECC) engine 147, an advanced encryption standard (AES) engine 148, a read-only memory (ROM) 149, and a bus BUS. The device controller 120 may further include a working memory (not shown) into which the FTL 143 is loaded, and, as the CPU 142 executes the FTL 143, a write operation and a read operation for the non-volatile memory 130 may be controlled. The bus BUS may facilitate communication between the above components.

The host interface 140 may transmit and receive packets to and from the host 200. A packet transmitted from the host 200 to the host interface 140 may include a command or data to be written to (or stored in) the non-volatile memory 130, and a packet transmitted from the host interface 140 to the host 200 may include a response to the command or data read from the non-volatile memory 130. The memory interface 141 may receive data to be written to the non-volatile memory 130. The memory interface 141 may be implemented to comply with a standard protocol such as Toggle or the Open NAND Flash Interface (ONFI).

The CPU 142, as a processor, may control processing of input data according to pre-defined operation rules stored in a memory group.

The CPU 142 may operate as a processor. The CPU 142 may receive a first endorsement and a first firmware image from the host 200. The first endorsement may be an endorsement generated by the host controller 220 based on a PDS. The first endorsement may include a valid value. The first firmware image may be a firmware image to be updated. The CPU 142 may perform a first integrity check on the first firmware image based on the PDS of PDS data, the first firmware image, and the first endorsement. Furthermore, the CPU 142 may generate a second endorsement based on a unique device secret (UDS) and the first firmware image in response to a pass result of the first integrity check. According to some example embodiments, the operation of the CPU 142 described above may be implemented in the AES engine 148. A PDS may be stored universally on all devices. Even when the storage device 100 is changed, the same PDS may be applied. A UDS may refer to a key or a value that is unique to each device. Therefore, each storage device 100 has a UDS different from that of another storage device 100. A UDS may be injected into the storage device 100 through a random number generator during the process of manufacturing the storage device 100. From among processes of manufacturing the storage device 100, a PDS and a UDS may be injected into the storage device 100 during an electrical die sorting (EDS) process or a packaging process.

When booting (or re-booting), the CPU 142 may load a firmware image stored in the non-volatile memory 130 into a volatile memory, e.g., the buffer memory 146. A firmware image loaded into the buffer memory 146 may be executed by the CPU 142 and/or the FTL 143. A firmware image stored in the non-volatile memory 130 may be referred to as a second firmware image.

The FTL 143 may perform various functions such as address mapping, wear-leveling, and garbage collection. The address mapping operation is an operation for translating a logical address received from the host 200 into a physical address used to actually store data in the non-volatile memory 130. The wear-leveling is a technique for preventing or reducing excessive degradation of a particular block by allowing blocks in the non-volatile memory 130 to be uniformly used and may be, for example, implemented through firmware technology for balancing erase counts of physical blocks. The garbage collection is a technique for securing usable capacity in the non-volatile memory 130 by copying valid data of an old block to a new block and then erasing the old block.

The packet manager 144 may generate packets according to a protocol of an interface negotiated with the host 200 or may parse various pieces of information from packets received from the host 200.

A one-time programmable (OTP) memory 145 is a non-volatile memory device and may store UDS data including a UDS. According to some example embodiments, the OTP memory 145 may further store PDS data including a PDS.

The buffer memory 146 may temporarily store data to be written to the non-volatile memory 130 or data read from the non-volatile memory 130. The buffer memory 146 may be a component provided in the device controller 120 but may also be provided outside the device controller 120.

The ECC engine 147 may perform an error detection and correction function for read data read from the non-volatile memory 130. In detail, the ECC engine 147 may generate parity bits regarding write data to be written to the non-volatile memory 130, and such parity bits may be stored in the non-volatile memory 130 together with the write data. When data is read from the non-volatile memory 130, the ECC engine 147 may correct an error of read data using parity bits read from the non-volatile memory 130 together with the read data and output error-corrected read data.

The AES engine 148 may perform at least one of an encryption operation and a decryption operation for data input to the device controller 120 using a symmetric-key algorithm.

In some example embodiments, the ROM 149 is a non-volatile memory device and may store PDS data including a PDS.

A memory group according to the inventive concepts may store data supporting various functions of the present device and programs for the operation of processors such as the CPU 142, may store input/output data, and may store a number of application programs or applications executed in the inventive concepts and data and instructions for operations according to the inventive concept. At least some of the application programs may be downloaded from an external server via wireless communication. According to some example embodiments, a memory group according to the inventive concepts may store UDS data and PDS data. For example, the memory group may include the OTP memory 145 that stores UDS data and PDS data. In some example embodiments, the memory group may include the OTP memory 145 that stores UDS data and the ROM 149 that stores PDS data.

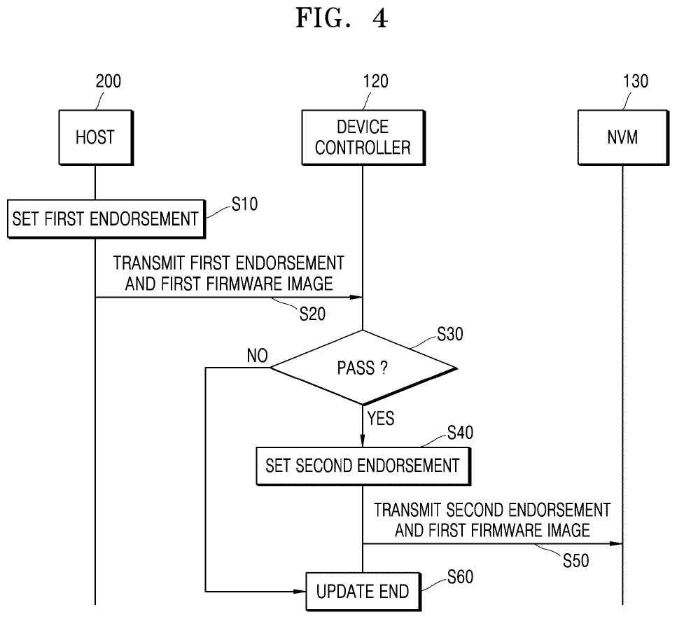

FIG. 4 is a diagram for describing a method of operating a system, according to some example embodiments.

Referring to FIG. 4, a method of operating the system 10 according to some example embodiments may be a method of updating firmware.

In operation S10, the host 200 sets a first endorsement. In operation S20, the host 200 transmits the first endorsement and a first firmware image to the device controller 120.

In operation S30, the device controller 120 receives the first endorsement and the first firmware image and performs an integrity check on the first firmware image.

In operation 540, when the first firmware image passes the integrity check (operation S30, YES), the device controller 120 sets a second endorsement.

In operation S50, the device controller 120 may transmit the second endorsement and the first firmware image to the non-volatile memory 130. In this case, the second endorsement may include a valid value. In operation S60, the device controller 120 may terminate the integrity check. In the event the first and second endorsements pass, data may be shared (read, write, etc.) between the host 200 and the storage device 100.

Alternatively, in operation S60, when the first firmware image fails the integrity check (operation S30, NO), the device controller 120 terminates the integrity check.

After the second endorsement (i.e., a UDS-based endorsement) is generated, an integrity check may be performed by using the UDS-based endorsement during booting. Accordingly, even when an external attacker launches a side-channel attack on the storage device 100, security may be maintained.

Additionally, or alternatively, even when an external attacker launches a side-channel attack on the storage device 100, there is an effect of robustly resisting to leakage of a PDS.

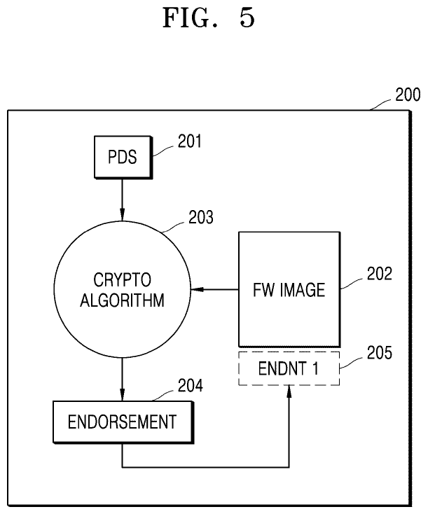

FIG. 5 is a diagram for describing an example embodiment of generating a first endorsement.

Referring to FIG. 5, the host 200 may apply a PDS 201 and a firmware image 202, which are stored in advance, to a crypto algorithm 203 to generate an endorsement 204. According to some example embodiments, the crypto algorithm 203 may be a message authentication code (MAC)-based crypto algorithm. For example, the MAC-based crypto algorithm may include one-way function-based algorithms such as hash based MAC or keyed-hash MAC (HMAC) and cipher-based MAC (CMAC). The firmware image 202 may be the first firmware image described above. According to some example embodiments, the host 200 may use the HMAC to generate the endorsement 204 from the PDS 201 and the firmware image 202. For example, the CPU 142 may use the PDS as a key and generate a first endorsement 205 by using the hash value of the first firmware image and the PDS. The host 200 may insert the endorsement 204 as the first endorsement 205 into the firmware image 202.

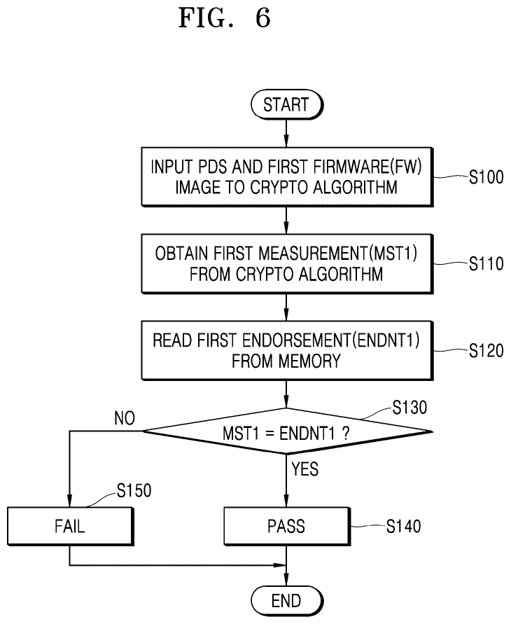

FIG. 6 is a flowchart for describing a method of performing an integrity check, according to some example embodiments.

Referring to FIG. 6, according to some example embodiments, a processor may generate a measurement from the PDS of the PDS data and the first firmware image by using a MAC-based crypto algorithm and determine whether the measurement and a first endorsement are identical to each other, thereby performing a first integrity check. The processor according to some example embodiments may be the CPU 142 of FIG. 2.

In operation S100, the CPU 142 inputs a PDS and a first firmware image to a crypto algorithm. In operation S110, the CPU 142 obtains a first measurement MST1 from the crypto algorithm. The first measurement MST1 may be a PDS-based measurement. In operation S120, the CPU 142 reads a first endorsement ENDNT1 from a memory. According to some example embodiments, the memory may be the buffer memory 146. Upon booting, the CPU 142 may load the first firmware image and the first endorsement ENDNT1 into the buffer memory 146, and the buffer memory 146 may temporarily store the first firmware image and the first endorsement ENDNT1. In operation S130, the CPU 142 determines whether the first measurement MST1 is the same as the first endorsement ENDNT1. When the first measurement MST1 is the same as the first endorsement ENDNT1 (operation S120, YES), in operation S140, the CPU 142 determines that the result of the first integrity check for the first firmware image is passed. At this time, the CPU 142 may generate a pass result, and the pass result may indicate that a measurement is the same as an endorsement. In the event the first endorsement passes, data may be shared (read, write, etc.) between the host 200 and the storage device 100. When the first measurement MST1 and the first endorsement ENDNT1 are different from each other (operation S120, NO), in operation S150, the CPU 142 determines that the result of the first integrity check for the first firmware image is fail. At this time, the CPU 142 may generate a failure result, and the failure result may indicate that a measurement and an endorsement are different from each other.

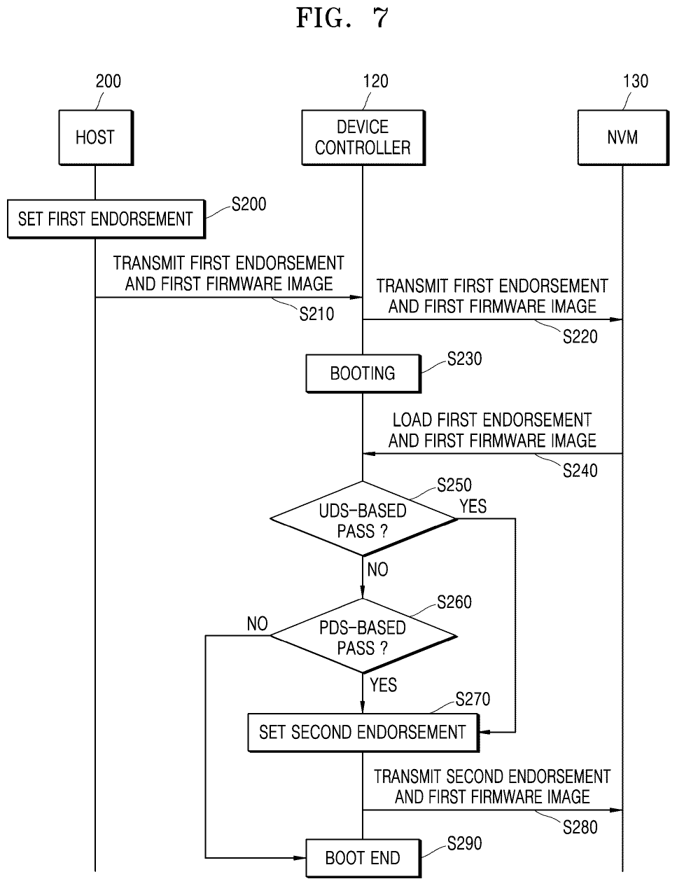

FIG. 7 is a diagram for describing a method of operating a system, according to some example embodiments.

Referring to FIG. 7, operation S200 is the same as operation S10 of FIG. 4. In operation S200, a first endorsement may be set according to some example embodiments described above with reference to FIG. 5. Operation S210 is the same as operation S20 of FIG. 4.

In operation s220, the device controller 120 may transmit the first endorsement and a first firmware image to the non-volatile memory 130. According to some example embodiments, the device controller 120 may control the non-volatile memory 130 to store the first endorsement and first firmware image in the non-volatile memory 130 prior to performing the first integrity check. According to some example embodiments, the CPU 142 may output a write command instructing to store the first endorsement and the first firmware image and an address to the non-volatile memory 130 before the first integrity check is performed on the first firmware image. The write command and the address are provided to the non-volatile memory 130, and the CPU 142 may provide the first endorsement and the first firmware image to the non-volatile memory 130.

After operation S220, a booting operation (or re-booting operation) may be performed in operation S230.

After booting, the device controller 120 loads the first endorsement and the first firmware image from the non-volatile memory 130 in operation S240. According to some example embodiments, the CPU 142 may load the first firmware image and the first endorsement stored in the non-volatile memory 130 into the buffer memory 146. According to some example embodiments, the non-volatile memory 130 may further store a second endorsement including an invalid value (or a dummy value). At this time, the CPU 142 may load the first firmware image, the first endorsement, and the second endorsement into the buffer memory 146.

In operation S250, the device controller 120 performs a UDS-based integrity check on the first firmware image. According to some example embodiments, the CPU 142 may perform a second integrity check on the first firmware image based on the UDS, the first firmware image, and the second endorsement.

When the UDS-based integrity check passes (operation S250, YES), in operation S270, the device controller 120 sets a second endorsement containing a valid value. According to some example embodiments, the CPU 142 may generate the second endorsement based on the UDS and the first firmware image.

In operation S280, the device controller 120 transmits the second endorsement and the first firmware image to the non-volatile memory 130. According to some example embodiments, the CPU 142 may output a write command instructing to store the second endorsement and the first firmware image and an address to the non-volatile memory 130. The write command and the address are provided to the non-volatile memory 130, and the CPU 142 may provide the second endorsement and the first firmware image to the non-volatile memory 130.

When the UDS-based integrity check fails (operation S250, NO), the device controller 120 performs a PDS-based integrity check on the first firmware image in operation S260. According to some example embodiments, the CPU 142 may perform a first integrity check on the first firmware image based on a PDS, the first firmware image, and the first endorsement.

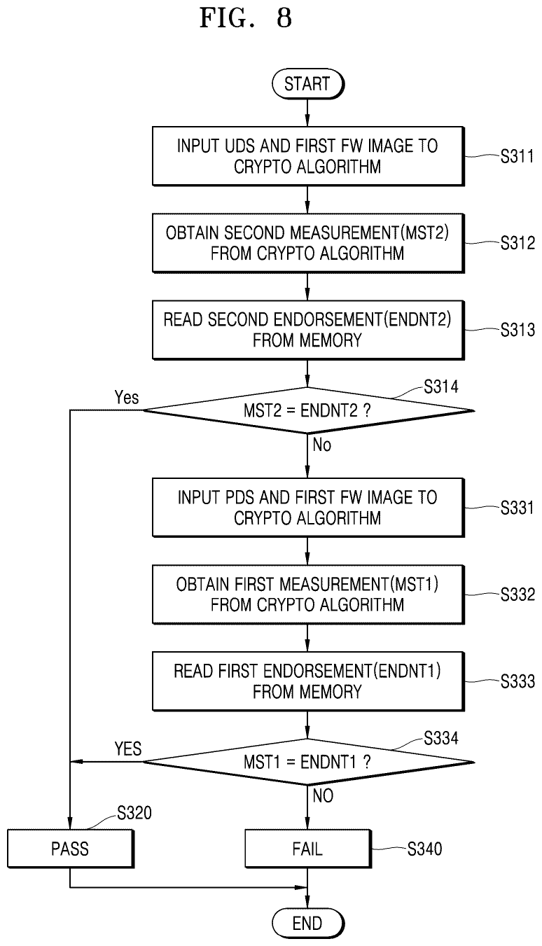

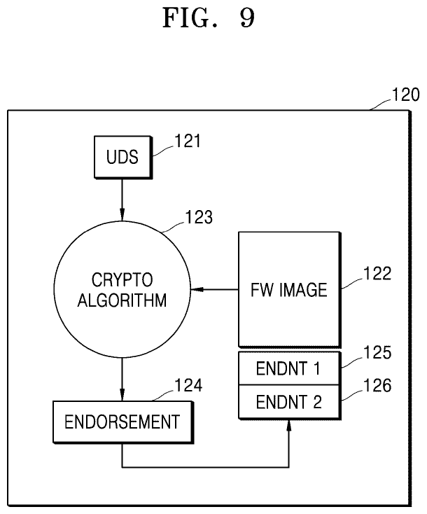

Some example embodiments of operations S250 and S260 are described below with reference to FIG. 8. Some example embodiments of operation S270 are described below with reference to FIG. 9.

When the PDS-based integrity check passes (operation S260, YES), operation S270 is performed. When the PDS-based integrity check fails (operation S260, NO), the device controller 120 may determine that the booting operation has failed and terminate or stop the booting operation in operation S290. In the event the first and second endorsements pass, data may be shared (read, write, etc.) between the host 200 and the storage device 100.

FIG. 8 is a flowchart for describing a method of performing a first integrity check and a second integrity check, according to some example embodiments.

Referring to FIG. 8, according to some example embodiments, a processor may generate a measurement from a UDS and a firmware image by using a MAC-based crypto algorithm and determine whether the measurement and a second endorsement are identical to each other, thereby performing a second integrity check. According to some example embodiments, the processor may perform a first integrity check in response to a failure result of the second integrity check. The processor according to some example embodiments may be the CPU 142 of FIG. 2.

In operation S311, the CPU 142 inputs a UDS and a first firmware image to a crypto algorithm. In operation S312, the CPU 142 obtains a second measurement MST2 from the crypto algorithm. The second measurement MST2 may be a UDS-based measurement. In operation S313, the CPU 142 reads a second endorsement ENDNT2 from a memory. According to some example embodiments regarding operation S313, the memory may be the buffer memory 146, and the second endorsement ENDNT2 may include a dummy value. In operation S314, the CPU 142 determines whether the second measurement MST2 is the same as the second endorsement ENDNT2. Operation S314 may be an operation in which the second integrity check according to the inventive concepts are performed. When the second measurement MST2 is the same as the second endorsement ENDNT2 (operation S314, YES), the result of the second integrity check for the first firmware image in operation S320 is passed.

When the second measurement MST2 and the second endorsement ENDNT2 are different from each other (operation S314, NO), according to some example embodiments, the processor may perform a first integrity check in response to a failure result indicating that the second measurement MST2 and the second endorsement ENDNT2 are different from each other. In operation S331, the CPU 142 inputs the PDS and the first firmware image to the crypto algorithm. In operation S332, the CPU 142 obtains the first measurement MST1 from the crypto algorithm. In operation S333, the CPU 142 reads the first endorsement ENDNT1 from the memory. The memory according to some example embodiments regarding operation S333 may be the buffer memory 146. In operation S334, the CPU 142 determines whether the first measurement MST1 is the same as the first endorsement ENDNT1. Operation S334 may be an operation in which the first integrity check according to the inventive concepts are performed. When the first measurement MST1 is the same as the first endorsement ENDNT1 (operation S334, YES), in operation S320, the result of the first integrity check for the first firmware image is passed. In the event the first and second endorsements pass, data may be shared (read, write, etc.) between the host 200 and the storage device 100. When the first measurement MST1 and the first endorsement ENDNT1 are different from each other (operation S334, NO), in operation S340, the result of the first integrity check for the first firmware image is fail.

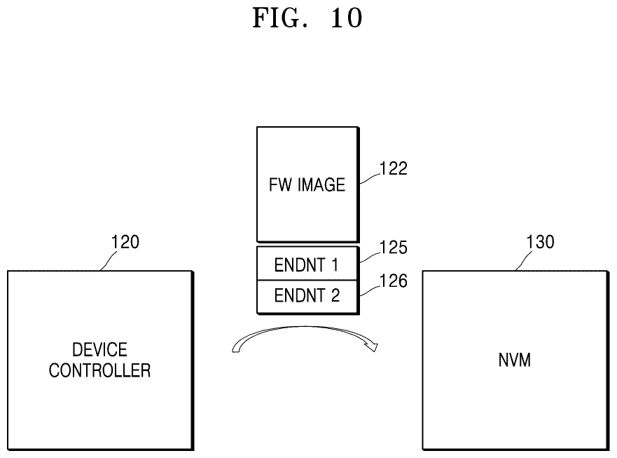

FIG. 9 is a diagram for describing some example embodiments of generating a second endorsement, and FIG. 10 is a diagram for describing some example embodiments of storing the second endorsement in a non-volatile memory.

Referring to FIG. 9, in response to a pass result of a first integrity check or in response to a pass result of a second integrity check, the device controller 120 may generate a second endorsement 126 based on a UDS 121 of pre-stored UDS data and a firmware image 122. The firmware image 122 may be referred as a first firmware image. According to some example embodiments, the CPU 142 may generate the second endorsement 126 from the UDS 121 and the firmware image 122 by using a MAC-based crypto algorithm 123. For example, the UDS 121 and the firmware image 122 that are stored in advance may be applied to the MAC-based crypto algorithm 203 to generate an endorsement 124. The MAC-based crypto algorithm 123 may include, for example, an HMAC, a CMAC, etc. The device controller 120 may insert the endorsement 124 as the second endorsement 126 into the firmware image 122. The second endorsement 126 may contain a valid value. Although FIG. 9 shows that the second endorsement 126 is inserted in addition to a first endorsement 125 of the firmware image 122, the inventive concepts are not limited thereto. According to some example embodiments, the first endorsement 125 may be replaced with the second endorsement 126. When booting is performed after the second endorsement 126 is generated and inserted (or replaced) into the firmware image 122, an integrity check for the firmware image 122 may be performed by using the second endorsement 126.

A PDS-based measurement and a UDS-based measurement may also be generated in a manner similar to that of the above-described embodiments.

Referring to FIG. 10, according to some example embodiments, the device controller 120 may control the non-volatile memory 130 to store the second endorsement 126 and the firmware image 122 in the non-volatile memory 130. According to some example embodiments, the device controller 120 may provide the first endorsement 125, the second endorsement 126, and the firmware image 122 to the non-volatile memory 130.

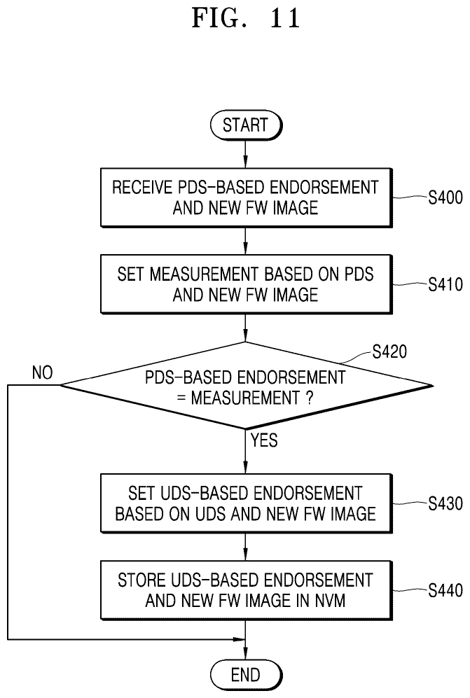

FIG. 11 is a flowchart of a method of operating a storage controller, according to some example embodiments.

Referring to FIG. 11, in operation S400, the storage controller receives a PDS-based endorsement and a new firmware image from a host device. The host device may correspond to the host 200 of FIG. 1. The storage controller may correspond to the device controller 120 in FIG. 1. The PDS-based endorsement may correspond to the first endorsement 205 of FIG. 5. The new firmware image may correspond to the firmware image 202 of FIG. 5.

In operation S410, the storage controller sets a measurement based on a PDS and the new firmware image. The measurement set in operation S410 may correspond to the first measurement MST1 of FIG. 8.

In operation S420, the storage controller determines whether the PDS-based endorsement is the same as the measurement. When the PDS-based endorsement and measurement are different from each other (operation S420, NO), the method is terminated.

When the PDS-based endorsement is the same as the measurement (operation S420, YES), in operation S430, the storage controller sets a UDS-based endorsement based on a UDS and the new firmware image. The UDS-based endorsement may correspond to the second endorsement 126 of FIG. 9.

In operation S440, the storage controller stores the UDS-based endorsement and the new firmware image in an NVM. The NVM may correspond to the non-volatile memory 130 of FIG. 1. After operation S440, data may be shared (read, write, etc.) between the host 200 and the storage device 100.

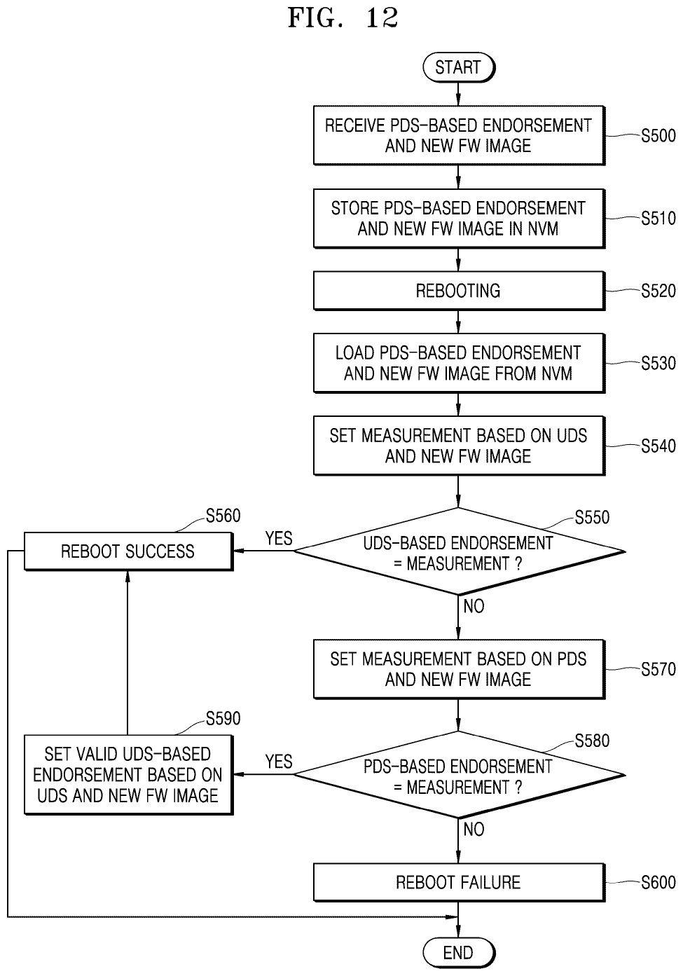

FIG. 12 is a flowchart of a method of operating a storage controller, according to some example embodiments.

Referring to FIG. 12, the method of FIG. 12 may illustrate an example embodiment of secure booting.

Operation S500 is the same as operation S400 of FIG. 11. In operation S510, the storage controller stores a PDS-based endorsement and a new firmware image in an NVM. The NVM may correspond to the non-volatile memory 130 of FIG. 1.

A re-booting operation is performed in operation S520. After re-booting, in operation S530, the storage controller loads a PDS-based endorsement and the new firmware image from the NVM. According to some example embodiments regarding operation S530, the NVM may further store a UDS-based endorsement including an invalid value, and the storage controller may also load the PDS-based endorsement, the UDS-based endorsement, and the new firmware image from the NVM.

In operation S540, the storage controller sets a measurement based on a UDS and the new firmware image. The measurement set in operation S540 may correspond to the second measurement MST2 of FIG. 8.

In operation S550, the storage controller determines whether the UDS-based endorsement is the same as the measurement. For example, the storage controller may read a loaded UDS-based endorsement and compare the measurement set in operation S540 with the UDS-based endorsement. When the UDS-based endorsement is the same as the measurement (operation S550, YES), the re-booting is successful in operation S560. After operation S560, data may be shared (read, write, etc.) between the host 200 and the storage device 100.

When the UDS-based endorsement and measurement are different from each other (operation S550, NO), in operation S570, the storage controller sets a measurement based on the PDS and the new firmware image. The measurement set in operation S570 may correspond to the first measurement MST1 of FIG. 8.

In operation S580, the storage controller determines whether the PDS-based endorsement is the same as the measurement. For example, the storage controller may read a loaded PDS-based endorsement and compare the measurement set in operation S570 with the ODS-based endorsement. When the PDS-based endorsement and measurement are different from each other (operation S580, NO), the re-booting fails in operation S600.

When the PDS-based endorsement is the same as the measurement (operation S580, YES), in operation S590, the storage controller sets a UDS-based endorsement based on a UDS and the new firmware image. The re-booting is successful in operation S560 after operation S590.

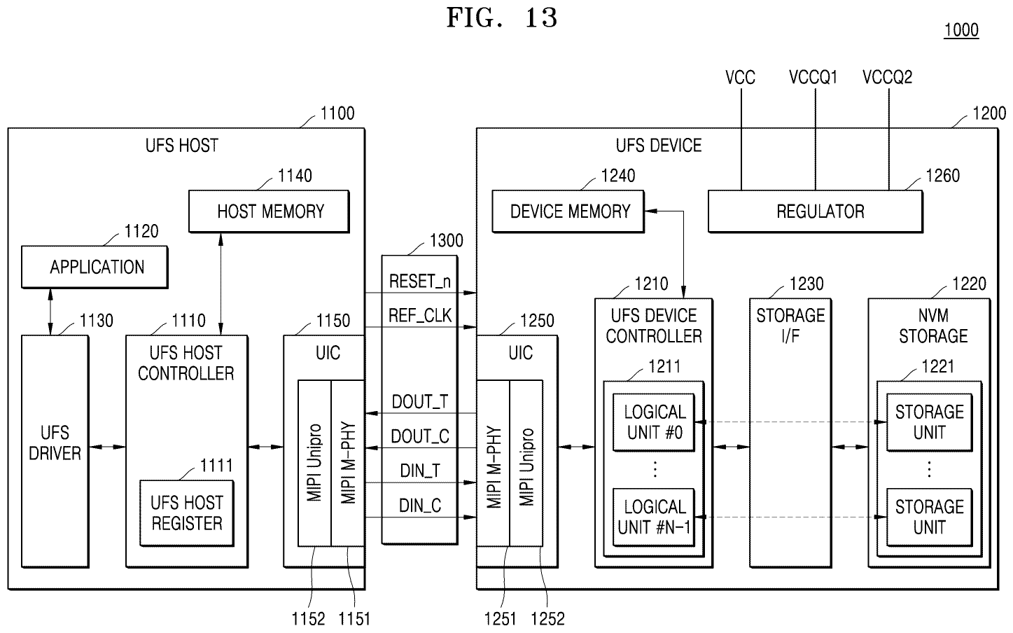

FIG. 13 is a diagram for describing a UFS system according to embodiments.

Referring to FIG. 13, a UFS system 1000 is a system that complies with the UFS standard published by the Joint Electron Device Engineering Council (JEDEC) and may include a UFS host 1100, a UFS device 1200, and a UFS interface 1300.

The UFS host 1100 and the UFS device 1200 may be connected to each other through the UFS interface 1300. When the host 200 of FIG. 1 is an AP, the UFS host 1100 may be implemented as a part of the AP. The UFS host controller 1110 may correspond to the host controller 220 of FIG. 1. The UFS device 1200 may correspond to the storage device 100 of FIG. 1, and a UFS device controller 1210 and a non-volatile memory 1220 may correspond to the device controller 120 and the non-volatile memory 130 of FIG. 1, respectively.

The UFS host 1100 may include a UFS host controller 1110, an application 1120, a UFS driver 1130, a host memory 1140, and a UFS interconnect (UIC) layer 1150. The UFS device 1200 may include the UFS device controller 1210, the non-volatile memory 1220, a storage interface 1230, a device memory 1240, a UIC layer 1250, and a regulator 1260. The non-volatile memory 1220 may include a plurality of memory units 1221. The memory unit 1221 may include a V-NAND flash memory with a 2D structure or a 3D structure but may also include a non-volatile memory of other types, e.g., PRAM and/or RRAM. The UFS device controller 1210 and the non-volatile memory 1220 may be connected to each other through the storage interface 1230. The storage interface 1230 may be implemented to comply with a standard protocol like Toggle or ONFI.

The application 1120 may refer to a program that may communicate with the UFS device 1200 to use functions of the UFS device 1200. The application 1120 may transmit an input/output request IOR to the UFS driver 1130 for input/output to/from the UFS device 1200. The input/output request IOR may refer to, but is not limited to, a request to read data, a request to write data, and/or a request to erase data.

The UFS driver 1130 may manage the UFS host controller 1110 through a UFS-host controller interface (HCI). The UFS driver 1130 may convert an input/output request generated by the application 1120 into a UFS command defined by the UFS standard and transmit the UFS command to the UFS host controller 1110. One input/output request may be transformed into a plurality of UFS commands. A UFS command may basically be a command defined by the SCSI standard but may also be a command dedicated to the UFS standard.

The UFS host controller 1110 may transmit a UFS command converted by the UFS driver 1130 to the UIC layer 1250 of the UFS device 1200 through the UIC layer 1150 and the UFS interface 1300. During the process, a UFS host register 1111 of the UFS host controller 1110 may serve as a command queue. According to some example embodiments, the UFS host controller 1110 may generate a first endorsement based on a PDS and a first firmware image and transmit the first endorsement and the first firmware image to the UFS device 1200 through the UIC layer 1150.

The UIC layer 1150 of the UFS host 1100 may include an MIPI M-PHY 1151 and an MIPI UniPro 1152, and the UIC layer 1250 of the UFS device 1200 may also include an MIPI M-PHY 1251 and an MIPI UniPro 1252.

The UFS interface 1300 may include a line for transmitting the reference clock REF_CLK, a line for transmitting a hardware reset signal RESET_n for the UFS device 1200, a pair of lines for transmitting a differential input signal pair DIN_t and DIN_c, and a pair of lines for transmitting a differential output signal pair DOUT_t and DOUT_c.

A frequency value of the reference clock REF_CLK provided from the UFS host 1100 to the UFS device 1200 may be one of four values including 19.2 MHz, 26 MHz, 38.4 MHz, and 52 MHz but is not limited thereto. The UFS host 1100 may change the frequency value of the reference clock REF_CLK during an operation, that is, while data transmission/reception is performed between the UFS host 1100 and the UFS device 1200. The UFS device 1200 may generate clocks of various frequencies from the reference clock REF_CLK provided from the UFS host 1100 by using a phase-locked loop (PLL) or the like. Also, the UFS host 1100 may set the value of the data rate between the UFS host 1100 and the UFS device 1200 through the frequency value of a reference clock. In other words, the value of the data rate may be determined depending on the frequency value of the reference clock.

The UFS interface 1300 may support multiple lanes, and each lane may be implemented as a differential pair. For example, the UFS interface 1300 may include one or more receive lanes and one or more transmit lanes. A pair of lines transmitting a differential input signal pair DIN_T and DIN_C may constitute a receive lane, and a pair of lines transmitting a differential output signal pair DOUT_T and DOUT_C may constitute a transmit lane. Although one transmit lane and one receive lane are shown, the numbers of transmit lanes and receive lanes may vary.

The receive lane and the transmit lane may transmit data through serial communication, and the structure in which the receive lane and the transmit lane are separated from each other allows full-duplex communication between the UFS host 1100 and the UFS device 1200. In other words, the UFS device 1200 may transmit data to the UFS host 1100 through the transmit lane even while receiving data from the UFS host 1100 through the receive lane. Also, control data, such as commands from the UFS host 1100 to the UFS device 1200, and data to be stored in the non-volatile memory 1220 of the UFS device 1200 or read from the non-volatile memory 1220 by the UFS host 1100 may be transmitted through the same lane. Therefore, there is no need to provide a separate lane for data transmission between the UFS host 1100 and the UFS device 1200 in addition to a pair of receive lanes and a pair of transmit lanes.

The UFS device controller 1210 of the UFS device 1200 may perform operations according to some example embodiments described above with reference to FIGS. 1 to 12. The UFS device controller 1210 may control the operation of the UFS device 1200 overall. The UFS device controller 1210 may manage the non-volatile memory 1220 through a logical unit (LU), which is a unit for storing logical data. The number of Lus 1211 may be 8 but is not limited thereto. The UFS device controller 1210 may include an FTL and convert a logical data address transmitted from the UFS host 1100 (e.g., a logical block address (LBA)) to a physical data address (e.g., a physical block address (PBA)) by using address mapping information of the FTL. In the UFS system 1000, a logical block for storing user data may have a size within a certain range. For example, the minimum size of a logical block may be set to 4 Kbyte.

When a command from the UFS host 1100 is input to the UFS device 1200 through the UIC layer 1250, the UFS device controller 1210 may perform an operation according to an input command and, when the operation is completed, transmit a completion response to the UFS host 1100.

For example, when the UFS host 1100 wants to store user data in the UFS device 1200, the UFS host 1100 may transmit a data storage command to the UFS device 1200. When a ready-to-transfer response indicating that the UFS device 1200 is ready to receive user data is received from the UFS device 1200, the UFS host 1100 may transmit the user data to the UFS device 1200. The UFS device controller 1210 may temporarily store received user data in the device memory 1240 and store the user data temporarily stored in the device memory 1240 at a selected location of the non-volatile memory 1220 based on the address mapping information of the FTL.

In some example embodiments, when the UFS host 1100 wants to read user data stored in the UFS device 1200, the UFS host 1100 may transmit a data read command to the UFS device 1200. The UFS device controller 1210, which has received the data read command, may read user data from the non-volatile memory 1220 based on the data read command and temporarily store read user data in the device memory 1240. During the read process, the UFS device controller 1210 may detect and correct errors in the read user data by using a built-in ECC engine (e.g., ECC engine 147). In detail, the ECC engine may generate parity bits regarding write data to be written to the non-volatile memory 1220, and such parity bits may be stored in the non-volatile memory 1220 together with the write data. When data is read from the non-volatile memory 1220, the ECC engine may correct an error of read data using parity bits read from the non-volatile memory 1220 together with the read data and output error-corrected read data.

Also, the UFS device controller 1210 may transmit user data temporarily stored in the device memory 1240 to the UFS host 1100. Also, the UFS device controller 1210 may further include an AES engine (e.g., AES engine 148). The AES engine may perform at least one of an encryption operation and a decryption operation for data input to the UFS device controller 1210 using a symmetric-key algorithm.

The UFS host 1100 may store commands to be transmitted to the UFS device 1200 in the UFS host register 1111, which may function as a command queue, in an order and transmit commands to the UFS device 1200 in the above-stated order. At this time, even when a previously transmitted command is still being processed by the UFS device 1200 (that is, even before receiving a notification that the previously transmitted command is processed by the UFS device 1200), the UFS host 1100 may transmit a next command waiting in the CQ to the UFS device 1200, and thus the UFS device 1200 may also receive a next command from the UFS host 1100 even while a previously transmitted command is being processed. A queue depth of commands that may be stored in such a command queue may be 32, for example. Also, a command queue may be implemented as a circular queue that indicates the start and the end of a command sequence stored in the queue through a head pointer and a tail pointer.

The plurality of memory units 1221 may each include a memory cell array (not shown) and a control circuit (not shown) that controls the operation of the memory cell array. The memory cell array may include a 2-dimensional memory cell array or a 3-dimensional memory cell array. A memory cell array includes a plurality of memory cells, and the memory cells may each be a single level cell (SLC) that stores 1 bit of data. However, the inventive concepts are not limited thereto, and the memory cells may each be a cell that stores 2 or more bit of data, e.g., a multilevel cell (MLC), a triple level cell (TLC), a quadruple level cell (QLC). A 3-dimensional memory cell array may include vertical NAND strings vertically oriented, such that at least one memory cell is positioned on top of another memory cell.

Power voltages like VCC, VCCQ1, and VCCQ2 may be input to the UFS device 1200. VCC is a main power voltage for the UFS device 1200 and may have a value from about or exactly 2.4 V to about or exactly 3.6 V. VCCQ1 is a power voltage for supplying a low range voltage mainly for the UFS device controller 1210 and may have a value from about or exactly 1.14 V to about or exactly 1.26 V. VCCQ2 is a power voltage for supplying a voltage in a range lower than VCC but higher than VCCQ1, is mainly for input/output interfaces like an MIPI M-PHY 1251, and may have a value from about or exactly 1.7 V to about or exactly 1.95 V. The power voltages may be supplied for the components of the UFS device 1200 via a regulator 1260. The regulator 1260 may be implemented as a set of unit regulators respectively connected to the above-stated power supply voltages.

Although not shown, according to some example embodiments, the UFS device 1200 may include an OTP memory to store UDS data and a ROM to store PDS data. According to some example embodiments, the UFS device 1200 may include an OTP memory that stores UDS data and PDS data.

As described above, when the inventive concepts are applied to a device that does not use an asymmetric cryptographic IP, such as a UFS, it is possible to perform a secure boot that provides improved security. Additionally, by using the above example embodiments, data may be more securely stored and the ability of malicious actors to access sensitive data, confidential data, technical data, etc., of the storage devices may be decreased and/or have reduced ability. Therefore, the improved devices and methods overcome the deficiencies of the conventional devices and methods related to asymmetric encryption while reducing resource consumption and increasing data clarity/security. For example, by using the disclosed methods, the boot operation and operation of a device, particularly relating to the use of a device with a UDS and PDS, may be possible and require fewer resources, such as memory access and/or power to drive circuitry to protect stored data.

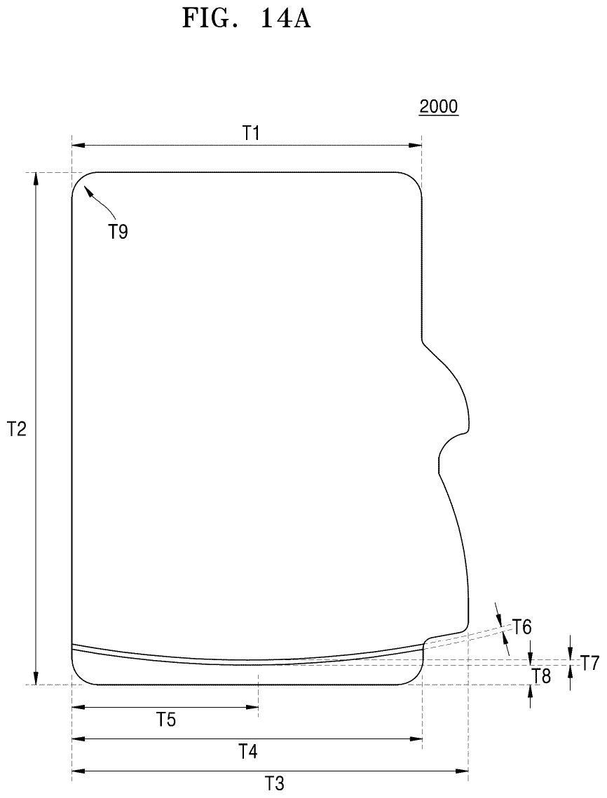

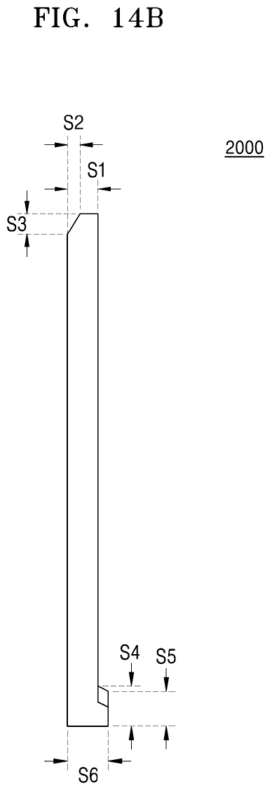

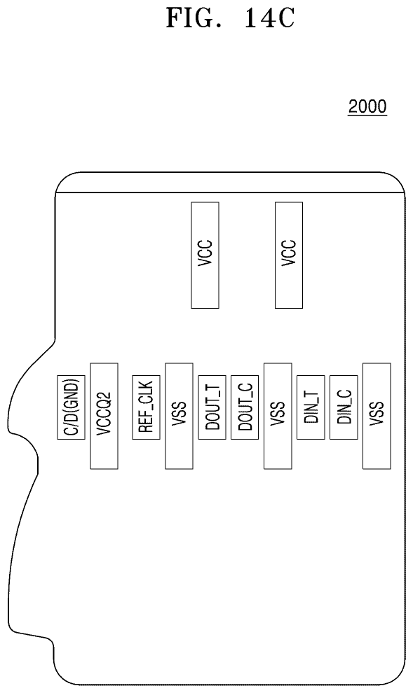

FIGS. 14A, 14B, and 14C are diagrams for describing the form factor of a UFS card.

When the UFS device 1200 described with reference to FIG. 13 is implemented in the form of a UFS card 2000, the external appearance of the UFS card 2000 may be as shown in FIGS. 4A to 14C.

FIG. 14A is an example top view of the UFS card 2000. Referring to FIG. 14A, it may be seen that the UFS card 2000 has an overall shark-like design. For example, regarding FIG. 14A, the UFS card 2000 may have the same or about the same dimension values as listed in Table 1 below.

TABLE 1

| Items | Dimension (mm) |
|---|---|
| T1 | 9.70 |
| T2 | 15.00 |
| T3 | 11.00 |
| T4 | 9.70 |
| T5 | 5.15 |
| T6 | 0.25 |
| T7 | 0.60 |
| T8 | 0.75 |
| T9 | R0.80 |

FIG. 14B is an example side view of the UFS card 2000. For example, regarding FIG. 14B, the UFS card 2000 may have the same or about the same dimension values as listed in Table 2 below.

TABLE 2

| Items | Dimension (mm) |
|---|---|
| S1 | 0.74 ± 0.06 |
| S2 | 0.30 |
| S3 | 0.52 |
| S4 | 1.20 |
| S5 | 1.05 |
| S6 | 1.00 |

FIG. 14C is an example bottom view of the UFS card 2000. Referring to FIG. 14C, a plurality of pins may be formed on the bottom surface of the UFS card 2000 for electrical contact with a UFS slot, and functions of the plurality of pins will be described later. Based on the symmetry between the top surface and the bottom surface of the UFS card 2000, some of the information regarding dimensions described with reference to FIG. 14A and Table 1 (e.g., T1 to T5 and T9) may also be applied to the bottom view of the UFS card 2000 as shown in FIG. 14C.

A plurality of pins may be formed on the bottom surface of the UFS card 2000 for electrical connection with a UFS host, and, according to FIG. 14C, the total number of the plurality of pins may be 12. Each pin may have a rectangular shape, and signal names corresponding to the plurality of pins are as shown in FIG. 14C. For schematic information regarding the plurality of pins which may have the same or about the same dimension values as in Table 3 below.

TABLE 3

| | Signal | | |
|---|---|---|---|
| Number | Name | Description | Dimension (mm) |
| 1 | VSS | Ground (GND) | 3.00 × 0.72 ± 0.05 |
| 2 | DIN_C | Differential input signal input from host to | 1.50 × 0.72 ± 0.05 |
| 3 | DIN_T | UFS card 2000 (DIN_C is negative node, | |
| | | DIN_T is positive node) | |
| 4 | VSS | Same as No. 1 | 3.00 × 0.72 ± 0.05 |
| 5 | DOUT_C | Differential output signal output from UFS | 1.50 × 0.72 ± 0.05 |
| 6 | DOUT_T | card 2000 to host (DOUT_C is negative | |
| | | node, DOUT_T is positive node) | |
| 7 | VSS | Same as No. 1 | 3.00 × 0.72 ± 0.05 |
| 8 | REF_CLK | Reference clock provided from host to UFS | 1.50 × 0.72 ± 0.05 |
| | | card 2000 | |
| 9 | VCCQ2 | Supply voltage with relatively low value as | 3.00 × 0.72 ± 0.05 |
| | | compared to Vcc, mainly provided for PHY | |
| | | interface or controller | |
| 10 | C/D(GND) | Signal for Card Detection | 1.50 × 0.72 ± 0.05 |
| 11 | VSS | Same as No. 1 | 3.00 × 0.80 ± 0.05 |
| 12 | Vcc | Main Power Voltage | |

When the terms “about” or “substantially” are used in this specification in connection with a numerical value, it is intended that the associated numerical value includes a manufacturing or operational tolerance (e.g., ±10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

While the inventive concepts have been particularly shown and described with reference to example embodiments thereof, it will be understood that various changes in form and details may be made therein without departing from the spirit and scope of the following claims.

1. A storage device comprising:
a memory group configured to store unique device secret (UDS) data comprising a UDS, and pre-installed device secret (PDS) data comprising a PDS; and
a processor configured to
receive a first endorsement generated based on the PDS and a first firmware image,
perform a first integrity check for the first firmware image based on the PDS of the PDS data, the first firmware image, and the first endorsement, and
generate a second endorsement based on the UDS and the first firmware image in response to a pass result of the first integrity check.

2. The storage device of claim 1, further comprising a non-volatile memory configured to store a second firmware image,
wherein the processor is configured to output a UDS-based endorsement, a write command instructing to store the first endorsement and the first firmware image, and an address to the non-volatile memory, before the first integrity check is performed.

3. The storage device of claim 2, wherein, based on the storage device being re-booted, the processor is configured to
load the first endorsement and the first firmware image stored in the non-volatile memory, and
perform a second integrity check for the first firmware image based on the UDS, the first firmware image, and the UDS-based endorsement.

4. The storage device of claim 3, wherein the processor is configured to
generates a measurement from the UDS and the first firmware image based on a message authentication code (MAC)-based crypto algorithm, and
perform the second integrity check based on determining whether the measurement and the UDS-based endorsement are identical to each other.

5. The storage device of claim 3, wherein the UDS-based endorsement comprises an invalid value, and
the processor is configured to perform the first integrity check in response to a failure result of the second integrity check.

6. The storage device of claim 1, wherein the processor is configured to
generate a measurement from the PDS and the first firmware image of the PDS data based on a message authentication code (MAC)-based crypto algorithm, and
perform the first integrity check based on determining whether the measurement and the first endorsement are identical to each other.

7. The storage device of claim 1, wherein
the processor is configured to generate the second endorsement from the UDS and the first firmware image based on a message authentication code (MAC)-based crypto algorithm, and
the second endorsement corresponds to a UDS-based endorsement comprising a valid value.

8. The storage device of claim 1, wherein the memory group comprises at least one non-volatile memory configured to store the UDS data and the PDS data.

9. (canceled)

10. A method of operating a storage controller, the method comprising:
receiving a first endorsement generated based on a pre-installed device secret (PDS) and a first firmware image;
performing a first integrity check for the first firmware image based on the PDS of pre-stored PDS data, the first firmware image, and the first endorsement; and,
in response to a pass result of the first integrity check, generating a second endorsement based on a unique device secret (UDS) of pre-stored UDS data and the first firmware image.

11. The method of claim 10, further comprising, before the performing of the first integrity check, controlling a non-volatile memory to store a UDS-based endorsement, the first endorsement, and the first firmware image in the non-volatile memory.

12. The method of claim 11, further comprising:
in response to a re-booting performed after the controlling of the non-volatile memory, loading the UDS-based endorsement, the first endorsement, and the first firmware image stored in the non-volatile memory; and
performing a second integrity check for the first firmware image based on the UDS, the first firmware image, and the UDS-based endorsement.

13. The method of claim 12, wherein the performing of the second integrity check comprises:
generating a measurement from the UDS and the first firmware image based on a message authentication code (MAC)-based crypto algorithm; and
determining whether the measurement and the UDS-based endorsement are identical to each other.

14. The method of claim 13, wherein, in the performing of the first integrity check, the first integrity check is performed in response to a failure result indicating that the measurement and the UDS-based endorsement are different from each other.

15. The method of claim 10, wherein the performing of the first integrity check comprises:
generating a measurement from the PDS and the first firmware image of the PDS data based on a message authentication code (MAC)-based crypto algorithm; and
determining whether the measurement and the first endorsement are identical to each other.

16. The method of claim 10, further comprising controlling a non-volatile memory to store the second endorsement and the first firmware image in the non-volatile memory.

17. A universal flash storage (UFS) system comprising:
a UFS host configured to generate a first endorsement based on a pre-installed device secret (PDS) and a first firmware image and transmit the first endorsement and the first firmware image; and
a UFS device configured to update firmware based on the first endorsement and the first firmware image,
the UFS device comprising
a memory group configured to store unique device secret (UDS) data comprising a UDS and PDS data including the PDS;
a processor configured to perform a first integrity check for the first firmware image based on the PDS of the PDS data, the first firmware image, and the first endorsement and, in response to a pass result of the first integrity check, generate a second endorsement based on the UDS; and
a non-volatile memory configured to store the second endorsement and the first firmware image.

18. The UFS system of claim 17, wherein the processor is configured to
generate a measurement from the PDS of the PDS data and the first firmware image based on a message authentication code (MAC)-based crypto algorithm, and
perform the first integrity check based on determining whether the measurement and the first endorsement are identical to each other.

19. The UFS system of claim 17, wherein the processor is configured to generate the second endorsement from the UDS and the first firmware image based on a message authentication code (MAC)-based crypto algorithm.

20. The UFS system of claim 17, wherein the memory group comprises:
one-time programmable (OTP) memory configured to store the UDS data; and
read-only memory (ROM) configured to store the PDS data.

21. The UFS system of claim 17, wherein the memory group comprises one-time programmable (OTP) memory configured to store the UDS data and the PDS data.
